(19) United States
(12) Patent Application Publication
(10) Pub. No.: US 2007/0217533 A1
(43) Pub. Date: Sep. 20, 2007

(54) Apparatus and method for channel estimation in a wireless communication system

(75) Inventors: Keun-Chul Hwang, Seongnam-si (KR); Sung-Woo Park, Suwon-si (KR); Soon-Young Yoon, Seoul (KR); Ki-Young Han, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/714,015

(22) Filed: Mar. 5, 2007

(30) Foreign Application Priority Data
Mar. 3, 2006 (KR) 2006-0020332
Apr. 10, 2006 (KR) 2006-0032231

(51) Int. Cl. H04K 1/10; H04L 27/06

(52) U.S. Cl. 375/260; 375/340

(57) ABSTRACT

An apparatus and method for channel estimation in a wireless communication system are provided, in which a first channel estimate is calculated using a pilot signal included in a received signal, a data signal included in the received signal is demodulated using the first channel estimate, a second channel estimate is calculated using the demodulated data signal, the first channel estimate is corrected using the second channel estimate and the data signal is demodulated using the corrected first channel estimate.

### PRIORITY

This application claims priority under 35 U.S.C. § 119 to an application filed in the Korean Intellectual Property Office on Mar. 3, 2006 and assigned Serial No. 2006-20332, and an application filed in the Korean Intellectual Property Office on Apr. 10, 2006 and assigned Serial No. 2006-32231, the contents of both of which are incorporated herein by reference.

### BACKGROUND OF THE INVENTION

1. Field of the Invention

The present invention relates generally to an apparatus and method for channel estimation in a wireless communication system, and in particular, to an apparatus and method for performing channel estimation using both a pilot signal and a data signal in a wireless communication system.

2. Description of the Related Art

Wireless communication systems have recently evolved into wireless packet data communication systems for transmitting high-speed, high-quality packet data for multimedia service in addition to the traditional voice service. For high-speed data transmission within limited frequency resources, the wireless communication system has adopted a technique called Adaptive Modulation and Coding (AMC), for adaptively adjusting a modulation order and a coding rate according to channel status. Radio channels frequently vary due to instances such as white noise, fading that causes change of received signal power, shadowing, a Doppler effect caused by a Mobile Station's (MS's) movement and frequent velocity change, interference from other users and multipath signals.

The radio channels change according to the status of radio resources. Because a signal transmitted, A receiver performs channel estimation to compensate for the distortion of the transmitted signal, due to a channel change. For instance, if a modulation scheme with a low order such as Binary Phase Shift Keying (BPSK) or Quadrature Phase Shift Keying (QPSK) is used, the receiver estimates only the phase of the received signal for channel compensation. Yet, in a high-order modulation scheme such as 8-ary Phase Shift Keying (8PSK) or 16-ary Quadrature Amplitude Modulation (16QAM), a plurality of symbols exists in each quadrant and there may exist several symbols with different amplitudes with respect to the same phase. Hence, the receiver needs to estimate the amplitude as well as the phase.

To enable the channel estimation, the transmitter transmits a known pilot signal to the receiver. After channel estimation, the receiver modulates a data signal based on the channel estimate. The accuracy of the channel estimation can be increased by more frequent transmission of more pilots from the transmitter.

Due to the limited resources (e.g. frequency and time), however, the increase of pilots decreases the throughput of the data signal. Accordingly, the transmitter transmits pilots at predetermined intervals in time and frequency, considering a Doppler frequency and a delay spread, as illustrated in FIG. 1.

FIG. 1 illustrates a pilot pattern in a conventional Orthogonal Frequency Division Multiplexing (OFDM) system.

Referring to FIG. 1, pilots are transmitted at time and frequency intervals in the OFDM system.

The receiver calculates the channel values of non-pilot areas, i.e. data using the pilots. For instance, the receiver can estimate the channel values of the data by linear interpolation of the estimated channel values of the pilots.

FIGS. 2A and 2B illustrate pilot patterns applied on a transmission block basis in the conventional OFDM system.

As illustrated in FIGS. 2A and 2B, the receiver can perform channel estimation on an area basis. That is, the channel estimate of a transmission block is that of pilots within the transmission block.

Referring to FIG. 2A, one transmission block is defined by a set of 4×3 subcarriers in the time-frequency domain. Pilots are carried on four subcarriers at the corners and data are carried on the other eight subcarriers in the transmission block.

Referring to FIG. 2B, one transmission block is defined by a set of 3×3 subcarriers in the time-frequency domain. Eight surrounding subcarriers deliver data and one center subcarrier carries a pilot.

FIG. 3 is a block diagram of a conventional receiver for channel estimation. Specifically, FIG. 3 illustrates an apparatus for performing channel estimation to compensate for the channel environment-incurred distortion of a received signal and thus to recover the original signal.

Referring to FIG. 3, the receiver includes a Fast Fourier Transform (FFT) processor 301, a channel estimator 303, a demodulator 305 and a decoder 307.

The FFT processor 301 converts a time signal received through an antenna to a frequency signal by FFT.

The channel estimator 303 estimates the channel of the received signal using a pilot signal included in the FFT signal. For instance, the channel estimator 303 may perform the channel estimation on a block-by-block basis as illustrated in FIGS. 2A and 2B. In this case, the channel value of a transmission block is the average of the channel values of pilots in the transmission block. Alternatively, the channel value of the transmission block can be achieved by linear interpolation of the channel values of the pilots.

The demodulator 305 compensates for the distortion of the FFT signal using the channel estimate received from the channel estimator 303 and demodulates the compensated signal in a demodulation method.

The decoder 307 decodes the demodulated data at a coding rate, thereby recovering information data.

As described above, the channel estimation performance of the wireless communication system depends on the number of pilots. If transmitters and receivers use the same pilot pattern, the receiver may suffer from the degradation of the channel estimation performance due to interference from other Base Stations (BSs) or other MSs. The received signal with the interference is expressed as the following Equation (1).
yᵢ=hᵢ^{desired}xᵢ^{desired}+hᵢ^{interference}xᵢ^{interference}+nᵢ (1)
where yᵢ denotes the received signal, hᵢ^{desired} denotes the channel information of a signal transmitted from a serving BS, xᵢ^{desired} denotes the signal transmitted from the serving BS, hᵢ^{interference} denotes the channel information of an interference signal from other BSs or other MSs, xᵢ^{interference} denotes the interference signal, and nᵢ denotes noise.

As described above, when a plurality of transmitters and receivers use the same pilot pattern for signal transmission and reception in the wireless communication system, the channel estimation performance is degraded because of interference from neighbor BSs or neighbor MSs, as noted from Equation (1).

### SUMMARY OF THE INVENTION

An object of the present invention is to substantially solve at least the above problems and/or disadvantages and to provide at least the advantages below. Accordingly, an aspect of the present invention is to provide an apparatus and method for improving channel estimation performance in a wireless communication system.

Another aspect of the present invention is to provide an apparatus and method for performing channel estimation using both a pilot signal and a data signal in a wireless communication system.

A further aspect of the present invention is to provide an apparatus and method for improving channel estimation performance by compensating a channel estimate calculated using a pilot signal of an n^{th} channel estimation unit by a channel estimate calculated using a data signal of an (n−1)^{th} channel estimation unit in a wireless communication system.

Still another aspect of the present invention is to provide an apparatus and method for improving channel estimation performance by compensating a channel estimate of an n^{th} channel estimation unit by a channel estimate of an (n−1)^{th} channel estimation unit in a wireless communication system.

According to the present invention, there is provided a method for channel estimation in a wireless communication system, in which a first channel estimate is calculated using a pilot signal included in a received signal, a data signal included in the received signal is demodulated using the first channel estimate, a second channel estimate is calculated using the demodulated data signal, the first channel estimate is corrected using the second channel estimate and the data signal is demodulated using the corrected first channel estimate.

According to the present invention, there is provided an apparatus for channel estimation in a wireless communication system, in which a channel estimator calculates a first channel estimate using a pilot signal included in a received signal, a channel estimation corrector corrects the first channel estimate using a second channel estimate, the second channel estimate is calculated using a demodulated data signal, and a demodulator demodulates a data signal included in the received signal using the corrected first channel estimate and provides the demodulated data signal to the channel estimation corrector according to the number of channel estimation iterations.

According to the present invention, there is provided a method for channel estimation in a wireless communication system, in which a first channel estimate is calculated using demodulated data of an (n−1)^{th} channel estimation unit, a second channel estimate is calculated using a pilot signal of an n^{th} channel estimation unit and the second channel estimate is corrected using the first channel estimate.

According to the present invention, there is provided an apparatus for channel estimation in a wireless communication system, in which a first channel estimator calculates a first channel estimate using demodulated data of an (n−1)^{th} channel estimation unit, a second channel estimator calculates a second channel estimate using a pilot signal of an n^{th} channel estimation unit and a first channel corrector corrects the second channel estimate using the first channel estimate.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a pilot pattern in a conventional OFDM system;

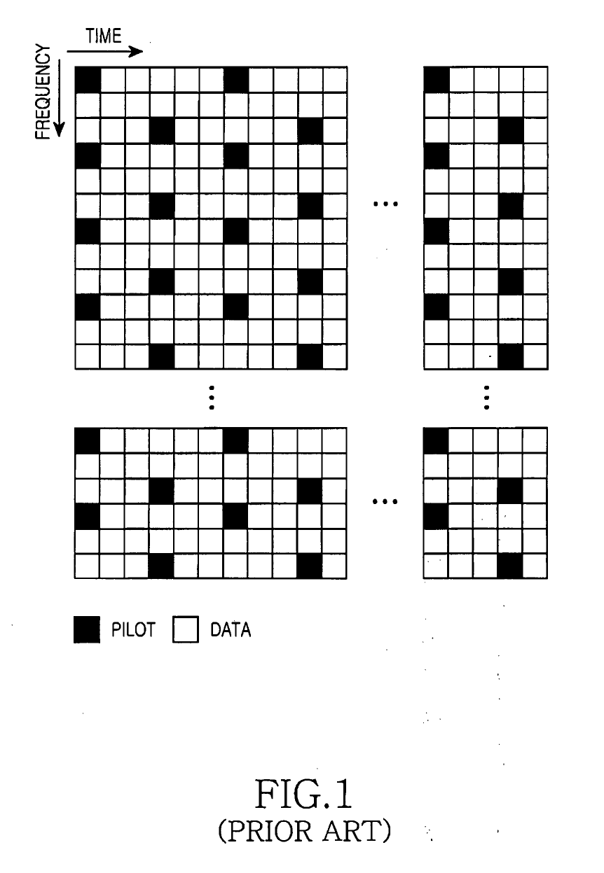

FIGS. 2A and 2B illustrate pilot patterns applied on a transmission block basis in the conventional OFDM system;

FIG. 3 is a block diagram of a conventional receiver for channel estimation;

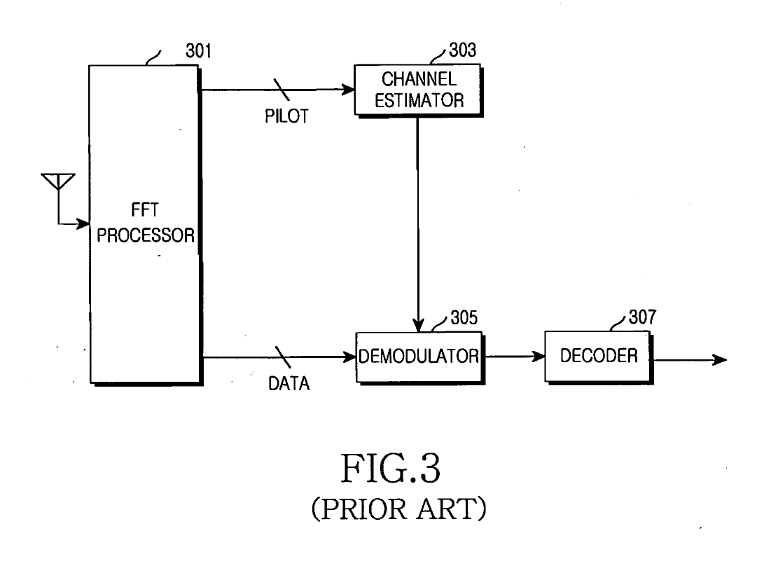

FIG. 4 is a block diagram of a receiver for channel estimation according to the present invention;

FIG. 5 is a block diagram of a receiver for channel estimation according to the present invention;

FIG. 6 is a flowchart illustrating a channel estimation operation according to the present invention;

FIG. 7 is a flowchart illustrating a channel estimation operation according to the present invention; and

FIG. 8 illustrates the structure of an OFDM frame in the OFDM system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

The present invention discloses a technique for performing channel estimation using both a pilot signal and a data signal in a wireless communication system.

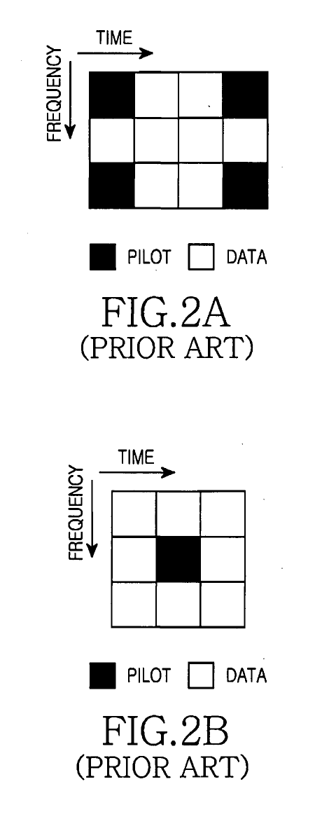

While the following description is made in the context of an Orthogonal Frequency Division Multiple Access (OFDMA) communication system, it also applies to a communication system using any other multiple access scheme. It is assumed that channel estimation is performed on a transmission block basis in the wireless communication system, as illustrated in FIG. 2.

In the wireless communication system, for channel estimation using both a pilot and a data signal, a channel estimate of a pilot signal of an n^{th} channel estimation unit is corrected using a channel estimate of a data signal of the n^{th} channel estimation unit. Also, a channel estimate of the n^{th} channel estimation unit can be corrected using that of an (n−1)^{th} channel estimation unit. A channel estimation unit is a transmission block defined by a set frequency and time.

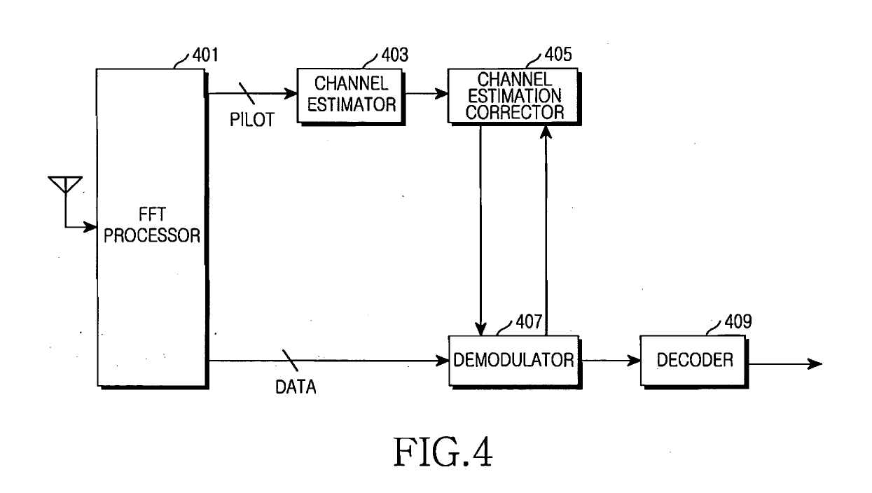

FIG. 4 is a block diagram of a receiver for channel estimation according to the present invention, which receiver corrects the channel estimate of a pilot signal using the channel estimate of a data signal in an n^{th} channel estimation unit.

Referring to FIG. 4, the receiver includes an FFT processor 401, a channel estimator 403, a channel estimation corrector 405, a demodulator 407 and a decoder 409.

The FFT processor 401 converts a time signal received through an antenna to a frequency signal by FFT and provides the converted signal to the channel estimator 403 and the demodulator 407.

The channel estimator 403 estimates the channel of the received signal using a pilot signal included in the FFT signal. For example, the channel estimation may take place on a transmission block basis, as illustrated in FIGS. 2A and 2B. In this case, the channel estimator 403 averages the channel values of pilots in a transmission block and uses the average as the channel value of the transmission block. Alternatively, the channel estimator 403 estimates the channel of the transmission block by linear interpolation of the channel values of the pilots.

The channel estimation corrector 405 performs channel estimation using a data signal demodulated by the demodulator 407 and corrects the pilot-based channel estimate received from the channel estimator 403 using the data-based channel estimate. While not shown, the channel estimation corrector 405 includes a channel estimator and a corrector. The channel estimator performs channel estimation on the demodulated data signal and the corrector corrects the pilot-based channel estimate using the data-based channel estimate.

For example, the channel estimation corrector 405 performs channel estimation by weighting the pilot-based channel estimate and the data-based channel estimate as follows in Equation (2).
ĥ_{i,refine}=βĥᵢ+(1−β)ĥ_{data},(iεP) (2)
where ĥᵢ denotes the pilot-based channel estimate, ĥ_{data} denotes the data-based channel estimate, i denotes the index of a pilot, P is a set of pilot indexes, and β denotes a weight value which is fixed, or calculated according to factors including a data demodulation error rate, a Doppler frequency and a delay spread.

The demodulator 407 compensates the FFT signal received from the FFT processor 401 by the channel estimate received from the channel estimation corrector 405 and provides the demodulated data to the channel estimation corrector 405 or the decoder 409. For example, after the data demodulation, the demodulator 407 compares the number of channel estimation iterations with a maximum iteration number. If the number of channel estimation iterations is less than the maximum iteration number, the demodulator 407 provides the demodulated data to the channel estimation corrector 405. If the number of channel estimation iterations reaches the maximum iteration number, the demodulator 407 provides the demodulated data to the decoder 409.

In the former case, the channel estimation corrector 405 receives a data signal expressed as Equation (3) from the demodulator 407. The size of each transmission block of the demodulated data is set, taking into account the Doppler frequency and the delay spread, such that the channel does not change within the transmission block. Therefore, all channel values of one transmission block can be fixed to a single channel estimate h_{data}. Thus, the wireless communication system can achieve the effect of averaging channel estimation errors caused by noise. In Equation (3),

$$\begin{matrix}{\sum }_{j = D} {\hat{x}}_{j}^{*} {y}_{j} = {\sum }_{j = D} {h}_{j} {\hat{x}}_{j}^{*} {x}_{j} + {\sum }_{j = D} {\hat{x}}_{j}^{*} {n}_{j} \\ = {h}_{data} {\sum }_{j = D} {\hat{x}}_{j}^{*} {x}_{j} + {\sum }_{j = D} {\hat{x}}_{j}^{*} {n}_{j}\end{matrix} \qquad ( 3 )$$

where j denotes the index of demodulated data, D denotes a set of data indexes, hⱼ denotes the pilot-based channel estimate, \hat{x}ⱼ denotes the demodulated data, yᵢ denotes the received signal, xᵢ denotes a signal transmitted by a transmitter, nᵢ denotes noise, and \hat{x}ⱼ* denotes the conjugate transpose of the demodulated data.

Equation (3) can be simplified to Equation (4), as follows:
y_{refine}=h_{data}x_{refine}+n_{refine} (4)
where y_{refine} denotes the sum of input signals at the channel estimation corrector 405,

$${\sum }_{j = D} {\hat{x}}_{j}^{*} {y}_{j} ,$$

x_{refine} denotes the sum of data signals,

$${\sum }_{j = D} {\hat{x}}_{j}^{*} {x}_{j} ,$$

and n_{refine} denotes the sum of noises

$${\sum }_{j = D} {\hat{x}}_{j}^{*} {n}_{j} .$$

The data signal x_{refine} transmitted by the transmitter is not known to the channel estimation corrector 405. Therefore, the channel estimation corrector 405 estimates the channel h_{data} using the demodulated data signal

$${\hat{x}}_{refine} = α {\sum }_{j = D} {\hat{x}}_{j}^{*} {\hat{x}}_{j}$$

instead of x_{refine}. α is a coefficient representing data demodulation accuracy and it is fixed or variable depending on the demodulated data. The data demodulation accuracy is determined according to Cyclic Redundancy Check (CRC) or Carrier-to-Interference and Noise Ratio (CINR).

Summation of the products between the demodulated data and the conjugate transpose \hat{x}ⱼ* in x_{refine} described in Equation (3) and Equation (4) causes the average of data incorrectly demodulated due to interference to be zero, while producing the sum of normal demodulated data, thereby ensuring reliability at or above a certain level. Since \hat{x}ⱼ* and nᵢ are independent of each other in n_{refine}, n_{refine} is averaged to zero despite continual additions of individual noise signals.

By applying Equation (3) and Equation (4) to Equation (1), the received signal of the channel estimation corrector 405 is given as Equation (5).

$$\begin{matrix}{\sum }_{j = D} ( { \hat{x}}_{j}^{desired} ) {y}_{j} = {\sum }_{j = D} {h}_{j}^{desired} ( {\hat{x}}_{j}^{desired} ) {x}_{j}^{desired} + \\ {\sum }_{j = D} {h}_{j}^{interference} ( {\hat{x}}_{j}^{desired} ) {x}_{j}^{interference} + \\ {\sum }_{j = D} ( {\hat{x}}_{j}^{desired} ) {n}_{j} \\ = {h}_{data}^{desired} {\sum }_{j = D} ( {\hat{x}}_{j}^{desired} ) {x}_{j}^{desired} + \\ {h}_{data}^{interference} {\sum }_{j = D} ( {\hat{x}}_{j}^{desired} ) {x}_{j}^{interference} + \\ {\sum }_{j = D} ( {\hat{x}}_{j}^{desired} ) {n}_{j}\end{matrix} \qquad ( 5 )$$

where yᵢ denotes the signal received from the demodulator 407 at the channel estimation corrector 405, hⱼ^{desired} denotes the channel of the normal demodulated data, xⱼ^{desired} denotes the normal demodulated data, hⱼ^{interference} denotes the channel of the erroneous demodulated data, and xⱼ^{interference} denotes the erroneous demodulated data.

The normal demodulated data is continuously summed by

$${\sum }_{j = D} ( {\hat{x}}_{j}^{desired} ) {x}_{j}^{desired} ,$$

and

$${\sum }_{j = D} ( {\hat{x}}_{j}^{desired} ) {x}_{j}^{interference}$$

is averaged to zero. Since

$${\sum }_{j = D} ( {\hat{x}}_{j}^{desired} ) {n}_{j}$$

is the sum of independent probability variables,

$${\sum }_{j = D} ( {\hat{x}}_{j}^{desired} ) {n}_{j}$$

is also averaged to zero.

In this manner, the channel estimation corrector 405 can estimate the channel of the demodulated data signal received from the demodulator 407 by Equation (5).

The decoder 409 decodes the data received from the demodulator 407 at a coding rate, thereby recovering information data.

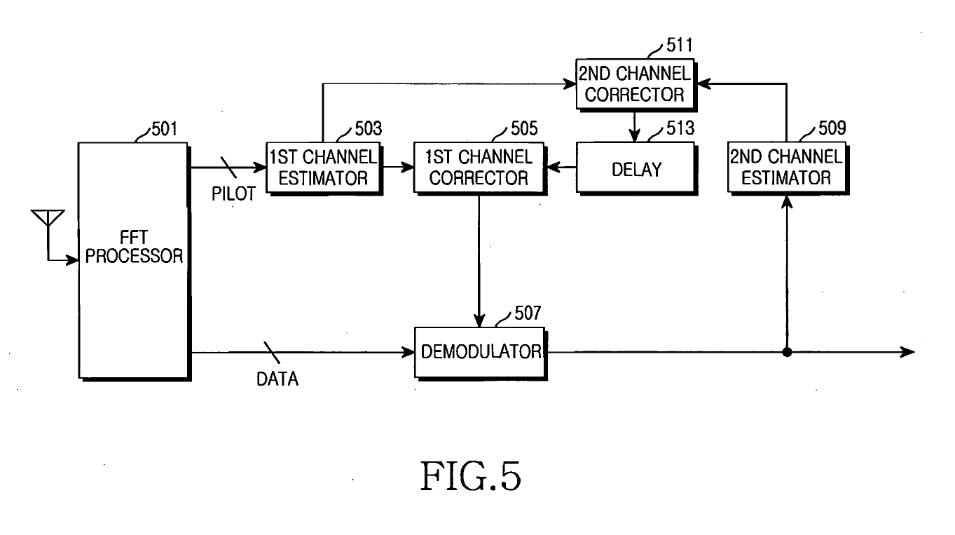

FIG. 5 is a block diagram of a receiver for channel estimation according to the present invention. The following description is made with the assumption that channel estimation is performed on an OFDM symbol basis.

Referring to FIG. 5, the receiver includes an FFT processor 501, first and second channel estimators 503 and 509, first and second channel correctors 505 and 511, a demodulator 507 and a delay 513.

The FFT processor 501 converts a time signal received through an antenna to a frequency signal by FFT.

The first channel estimator 503 estimates the channel of an n^{th} OFDM symbol using a pilot signal included in the FFT signal received from the FFT processor 501.

The first channel corrector 505 corrects the pilot-based channel estimate received from the first channel estimator 505 using a channel estimate received from the delay 513. Specifically, the first channel corrector 505 corrects a pilot-based channel estimate of the n^{th} OFDM symbol using the channel estimate of an (n−1)^{th} OFDM symbol. The channel estimate of the (n−1)^{th} OFDM symbol is obtained by compensating a pilot-based channel estimate of the (n−1)^{th} OFDM symbol using a data-based channel estimate of the (n−1)^{th} OFDM symbol, as expressed in Equation (6).
ĥₙ=βĥ_{n,p}+(1−β)ĥ_{n-1,refine} (6)
where ĥₙ denotes the corrected channel estimate of the n^{th} OFDM symbol, ĥ_{n,p} denotes the pilot-based channel estimate of the n^{th} OFDM symbol, and ĥ_{n-1,refine} denotes the channel estimate of the (n−1)^{th} OFDM symbol, expressed as Equation (7). β denotes a weight value as a function of the time interval between the n^{th} and (n−1)^{th} OFDM symbols. That is, β is determined according to the correlation between the channel values of the two symbols. If the two symbols are successive and the Doppler frequency is small, the correlation between the symbols is high. Thus, β is set to approximately 0.5. If the two symbols are not successive or the Doppler frequency is larger, the correlation is low and thus β is set to be close to 1, to thereby reduce the influence from the previous symbol.

The demodulator 507 compensates the FFT signal received from the FFT processor 501 using the corrected channel estimate received from the first channel corrector 505. Then the demodulator 507 demodulates the compensated signal in a demodulation method.

At the same time, the demodulator 507 provides the demodulated data of the n^{th} OFDM symbol to the second channel estimator 509 in order to increase the accuracy of channel estimation of an (n+1)^{th} OFDM symbol. While not shown, the demodulator 507 provides the demodulated data to a decoder.

The second channel estimator 509 performs channel estimation using the data of the n^{th} OFDM symbol.

The second channel corrector 511 corrects a channel estimate received from the first channel estimator 503 using the channel estimate received form the second channel estimator 509, thereby increasing the accuracy of the channel estimate calculated by the first channel estimator 503. Specifically, the second channel corrector 501 corrects the pilot-based channel estimate of the n^{th} OFDM symbol received from the first channel estimator 503 using the data-based channel estimate of the n^{th} OFDM symbol received from the second channel estimator 509 by the following Equation (7).
ĥ_{n,refine}=αĥ_{n,p}+(1−α)ĥ_{n,d} (7)
where ĥ_{n,refine} denotes the corrected channel estimate of the n^{th} OFDM symbol, ĥ_{n,p} denotes the pilot-based channel estimate of the n^{th} OFDM symbol, and ĥ_{n,d} denotes the data-based channel estimate of the n^{th} OFDM symbol. α denotes a weight value based on a data demodulation success rate. It is fixed, or variable for each OFDM symbol according to CINR or CRC check.

The delay 513 delays the channel estimate received from the second channel corrector 511, thus synchronizing between the outputs of the first channel estimator 503 and the second channel corrector 511. For instance, the delay 513 synchronizes the pilot-based channel estimate of the n^{th} OFDM symbol from the first channel estimator 503 to the channel estimate of the (n−1)^{th} OFDM symbol from the second channel corrector 511 by delaying the channel estimate of the (n−1)^{th} OFDM symbol.

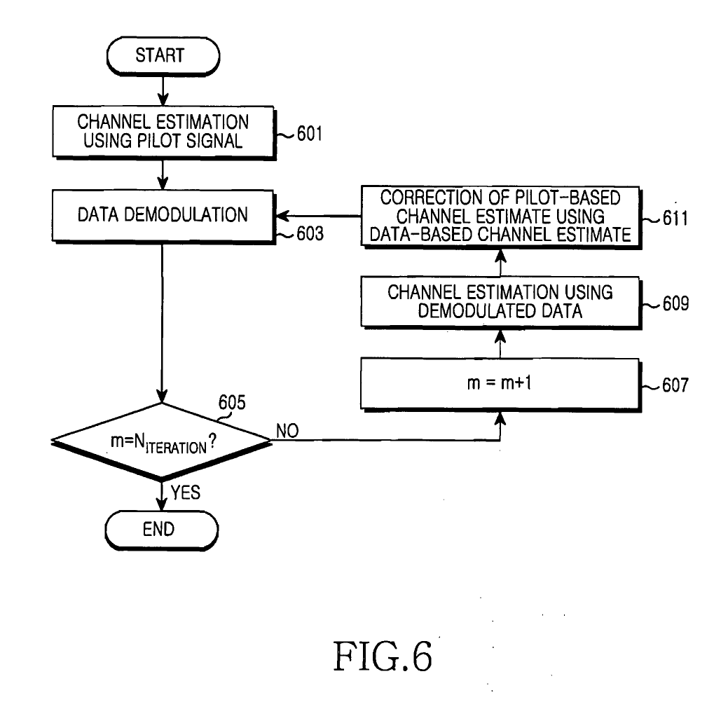

FIG. 6 is a flowchart illustrating a channel estimation operation according to the present invention.

Referring to FIG. 6, a receiver performs channel estimation using a pilot signal of a received signal in step 601.

In step 603, the receiver compensates for the distortion of the received data using the channel estimate in a demodulation method.

The receiver compares the number m of channel estimation iterations for the demodulated signal with a maximum iteration number Nᵢₜₑᵣₐₜᵢₒₙ in step 605. The initial value of m is 0.

If m is equal to N^{iteration}, the receiver ends the algorithm. If m is less than N^{iteration} (m<Nᵢₜₑᵣₐₜᵢₒₙ), the receiver increases m by 1 in step 607.

In step 609, the receiver performs channel estimation using the demodulated data by Equation (3) and Equation (4).

In step 611, the receiver corrects the pilot-based channel estimate using the demodulated data-based channel estimate. For example, the receiver corrects the pilot-based channel estimate by weighting the data-based channel estimate and the pilot-based channel estimate according to Equation (2).

The receiver then returns to step 603 where it compensates for the channel environment-caused distortion of the received signal using the corrected channel estimate.

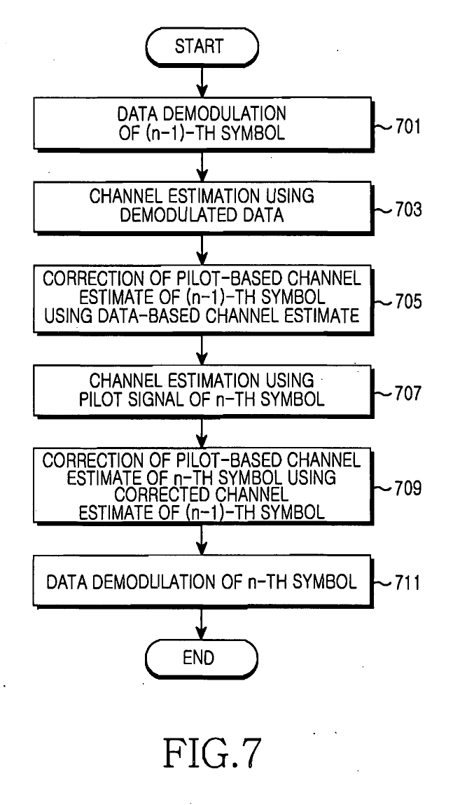

FIG. 7 is a flowchart illustrating a channel estimation operation according to the present invention. The following description is made with the assumption that a first channel estimate is a pilot-based channel estimate and a second channel estimate is a demodulated data-based channel estimate.

Referring to FIG. 7, a receiver demodulates the data of an (n−1)^{th} OFDM symbol in step 701. For example, the receiver compensates for the distortion of the data of the (n−1)^{th} OFDM symbol using the first channel estimate of an (n−2)^{th} OFDM symbol corrected with the second channel estimate of the (n−2)^{th} OFDM symbol. Then, the receiver demodulates the compensated data.

In step 703, the receiver performs channel estimation on the demodulated data.

The receiver corrects the first channel estimate of the (n−1)^{th} OFDM symbol using the second channel estimate of the (n−1)^{th} OFDM symbol in step 705. Specifically, the receiver creates a new channel estimate by weighting the first and second channel estimates of the (n−1)^{th} OFDM symbol by Equation. (7). Weight values applied to the first and second estimates are determined according to a data demodulation success rate.

In step 707, upon receipt of an n^{th} OFDM symbol, the receiver performs channel estimation using a pilot signal of the n^{th} OFDM symbol.

The receiver then corrects the first channel estimate of the n^{th} OFDM symbol using the corrected first channel estimate of the (n−1)^{th} OFDM symbol in step 709. For example, the receiver corrects the first channel estimate of the n^{th} OFDM symbol by weighting the first channel estimate of the n^{th} OFDM symbol and the corrected first channel estimate of the (n−1)^{th} OFDM symbol by Equation (6). Weight values used for the weighting are determined according to the correlation between the channel values of the (n−1)^{th} and n^{th} OFDM symbols.

After correcting the first channel estimate of the n^{th} OFDM symbol, the receiver compensates for the distortion of the data of the n^{th} OFDM symbol using the corrected first channel estimate of the n^{th} OFDM symbol and demodulates the data of the n^{th} OFDM symbol using the distortion-compensated signal in step 711.

Then the receiver ends the algorithm.

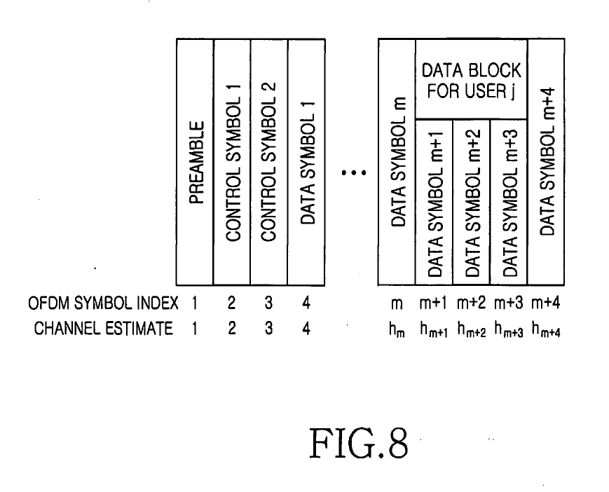

As described above, the receiver corrects the channel estimate of the n^{th} OFDM symbol by weighting the channel estimates of the (n−1)^{th} and n^{th} OFDM symbols according to the correlation between the channel estimates. Therefore, when a frame is configured as illustrated in FIG. 8, a different weight value can be applied to each data symbol.

FIG. 8 illustrates the structure of an OFDM frame in the OFDM system according to the present invention. This frame structure complies with Institute of Electrical and Electronics Engineers (IEEE) 802.16.

Referring to FIG. 8, a preamble of the frame is all pilots without any data. The receiver estimates the channel of the frame using the preamble. Notably, the receiver determines a weight value according to the correlation between the channel values of the preamble and a data symbol. When estimating the channel of data symbol m, the receiver decreases the weight β, thus weighting the channel estimate of the preamble more heavily because the preamble is highly correlated with data symbol m. If the receiver estimates the channel of data symbol m+4, it increases the weight β, thus weighting the channel estimate of the preamble less heavily because the correlation between the preamble and data symbol m+4 is low.

In accordance with the present invention as described above, channel estimation based on both a pilot signal and a data symbol overcomes the problem of a decreased channel estimation accuracy encountered with channel estimation based on the pilot signal only, especially in a cell boundary suffering severe interference in a wireless communication system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for channel estimation in a wireless communication system, comprising:
calculating a first channel estimate using a pilot signal included in a received signal;
demodulating a data signal included in the received signal using the first channel estimate;
calculating a second channel estimate using the demodulated data signal;
correcting the first channel estimate using the second channel estimate; and
demodulating the data signal using the corrected first channel estimate.

2. The method of claim 1, wherein each of the demodulations comprises:
compensating for distortion of the data signal using the first channel estimate; and
demodulating the compensated data signal according to a modulation scheme.

3. The method of claim 1, wherein the calculation of the second channel estimate comprises:
multiplying an amount of demodulated data by conjugate transposes of the demodulated data to produce products;
summing the products; and
performing channel estimation using the sum of the products.

4. The method of claim 1, wherein the correction of the first channel estimate further comprises:
checking weight values for correcting the first channel estimate; and
correcting the first channel estimate by applying the weight values to the first channel estimate and the second channel estimate.

5. The method of claim 4, wherein the weight values are one of fixed and variable according to a channel environment.

6. The method of claim 5, wherein the weight values are determined according to at least one of a Doppler frequency, a delay spread, and a data demodulation error rate.

7. The method of claim 1, further comprising comparing a number of channel estimation iterations of the demodulated data signal with a maximum iteration number, wherein if the number of the channel estimations iterations is less than the maximum iteration number, the second channel estimate is calculated.

8. The method of claim 7, further comprising decoding the demodulated data signal, if the number of the channel estimation iterations is equal to the maximum iteration number.

9. An apparatus for channel estimation in a wireless communication system, comprising:
a channel estimator for calculating a first channel estimate using a pilot signal included in a received signal;
a channel estimation corrector for correcting the first channel estimate using a second channel estimate, the second channel estimate being calculated using a demodulated data signal; and
a demodulator for demodulating a data signal included in the received signal using the corrected first channel estimate and providing the demodulated data signal to the channel estimation corrector according to a number of channel estimation iterations.

10. The apparatus of claim 9, wherein the channel estimation corrector further comprises:
a channel estimator for calculating the second channel estimate using the demodulated data signal received from the demodulator; and
a corrector for correcting the first channel estimate using the second channel estimate.

11. The apparatus of claim 10, wherein the channel corrector multiplies an amount of demodulated data by conjugate transposes of the demodulated data, sums products of the multiplication, and performs channel estimation using the sums.

12. The apparatus of claim 10, wherein the corrector corrects the first channel estimate by applying weight values to the first channel estimate and the second channel estimate and summing the weighted first and second channel estimates.

13. The apparatus of claim 12, wherein the weight values are one of fixed and variable according to a channel environment.

14. The apparatus of claim 13, wherein the weight values are determined according to at least one of a Doppler frequency, a delay spread, and a data demodulation error rate.

15. The apparatus of claim 9, wherein the demodulator demodulates the data signal using the corrected first channel estimate and provides the demodulated data to the channel estimation corrector, if the number of the channel estimation iterations is less than a maximum iteration number.

16. The apparatus of claim 15, further comprising a decoder for channel-decoding the demodulated data signal, thereby recovering information data, wherein if the number of the channel estimation iterations is equal to the maximum iteration number, the demodulator provides the demodulated data signal to the decoder.

17. A method for channel estimation in a wireless communication system, comprising:
calculating a first channel estimate using demodulated data of an (n−1)^{th} channel estimation unit;
calculating a second channel estimate using a pilot signal of an n^{th} channel estimation unit; and
correcting the second channel estimate using the first channel estimate.

18. The method of claim 17, wherein the correction of the second channel estimate further comprises:
checking weight values for correcting the second channel estimate; and
correcting the second channel estimate by applying the weight values to the first channel estimate and the second channel estimate.

19. The method of claim 18, wherein the weight values are determined according to a correlation between channels of the (n−1)^{th} channel estimation unit and the n^{th} channel estimation unit.

20. The method of claim 17, further comprising:
demodulating data of the n^{th} channel estimation unit using the corrected second channel estimate; and
estimating a channel of the n^{th} channel estimation unit using the demodulated data.

21. The method of claim 20, further comprising decoding the demodulated data.

22. The method of claim 17, further comprising:
calculating a third channel estimate using a pilot signal of the (n−1)^{th} channel estimation unit; and
correcting the third channel estimate using the first channel estimate,
wherein the correction of the second channel estimate includes correcting the second channel estimate using the corrected third channel estimate.

23. The method of claim 22, wherein the correction of the third channel estimate further comprises:
checking weights for correcting the third channel estimate; and
correcting the third estimate by applying the weight values to the first channel estimate and the third channel estimate.

24. The method of claim 23, wherein the weight values are one of fixed and variable according to a demodulation success rate of the data signal.

25. The method of claim 24, wherein the demodulation success rate is determined according to at least one of Carrier-to-Interference and Noise Ratio (CINR) and Cyclic Redundancy Check (CRC).

26. An apparatus for channel estimation in a wireless communication system, comprising:
a first channel estimator for calculating a first channel estimate using demodulated data of an (n−1)^{th} channel estimation unit;
a second channel estimator for calculating a second channel estimate using a pilot signal of an n^{th} channel estimation unit; and
a first channel corrector for correcting the second channel estimate using the first channel estimate.

27. The apparatus of claim 26, wherein the first channel corrector corrects the second channel estimate by applying weight values to the first channel estimate and the second channel estimate.

28. The apparatus of claim 27, wherein the weight values are one of fixed and determined according to a correlation between channels of the (n−1)^{th} channel estimation unit and the n^{th} channel estimation unit.

29. The apparatus of claim 26, further comprising a second channel corrector for correcting a third channel estimate using the first channel estimate, the third channel estimate being calculated using a pilot signal of the (n−1)^{th} channel estimation unit, wherein the first channel corrector corrects the second channel estimate using the corrected third channel estimate.

30. The apparatus of claim 29, wherein the second channel corrector corrects the third estimate by applying weight values to the first channel estimate and the third channel estimate.

31. The apparatus of claim 30, wherein the weight values are one of fixed and determined according to a demodulation success rate of the data signal.

32. The apparatus of claim 26, further comprising a demodulator for demodulating a data signal of the n^{th} channel estimation unit using the corrected second channel estimate and providing the demodulated data to the first channel estimator.

33. A wireless communication system for channel estimation comprising:
means for calculating a first channel estimate using a pilot signal included in a received signal;
means for demodulating a data signal included in the received signal using the first channel estimate;
means for calculating a second channel estimate using the demodulated data signal; and
means for correcting the first channel estimate using the second channel estimate.
